(19) United States
(12) Patent Application Publication
(10) Pub. No.: US 2005/0262529 A1
(43) Pub. Date: Nov. 24, 2005

(54) Method, apparatus and system for remote real-time access of multimedia content

(76) Inventors: Raja Neogi, Portland, OR (US); Kam Lee, Vancouver (CA)

Correspondence Address: INTEL CORPORATION, P.O. BOX 5326, SANTA CLARA, CA, 95056-5326, US

(21) Appl. No.: 10/850,284

(22) Filed: May 20, 2004

(51) Int. Cl. H04N 7/167; H04N 7/173

(52) U.S. Cl. 725/31; 380/210

(57) ABSTRACT

A method, apparatus and system for remote real-time access of personal multimedia content is disclosed. One embodiment of the present invention enables users to securely access their personal multimedia content from remote locations while retaining the ability to manipulate the content (hereafter referred to as “trick play”). Numerous components of a system, including a service agent, a licensing agent and a distribution agent, may manage various aspects of this functionality. In one embodiment, a service agent may generate index table metadata that enables the distribution agent to respond to trick play requests from the user.

### BACKGROUND

Historically, consumers have been limited in their flexibility to access their personal content. For example, users have traditionally been limited to recording broadcast programs on video cassettes, which then had to be physically accessible to playback the recorded content. In recent times, various digital transmission, recording and storage devices have become available, such as personal video recorders (“PVRs”). PVRs enable viewers to record, store and view various types of content in a digital format. Similar audio recording and storage devices are also available. These audio/video devices nonetheless still physically limit the consumer because the device has to be present for the user to access the content. In other words, if the PVR resides at a viewer's home, the viewer has to be physically present at home to access any stored content from the PVR.

Users today, however, are becoming increasingly mobile and as a result, their needs are becoming more sophisticated. Thus, as technology advances, many users are taking advantage of remote access services, such as email forwarding to cellular telephones. These types of services provide users with increased flexibility in accessing their content, regardless of their current location. There is, however, no existing methodology by which a user may securely access their personal content from a remote location.

### BRIEF DESCRIPTION OF THE DRAWINGS

The present invention is illustrated by way of example and not limitation in the figures of the accompanying drawings in which like references indicate similar elements, and in which:

FIG. 1 illustrates a system according to an embodiment of the present invention;

FIG. 2 illustrates conceptually an embodiment of the present invention;

FIG. 3 illustrates an example of trick play metadata according to an embodiment of the present invention; and

FIG. 4 is a flowchart illustrating an embodiment of the present invention.

### DETAILED DESCRIPTION

Embodiments of the present invention provide a method, apparatus and system for remote real-time access of personal multimedia content. The term “personal multimedia content” as used herein shall comprise any continuous and/or streaming media content (e.g., audio and/or video content) that the user has a legal right to access, including personal video content, personal voice mail and pre-paid premium content. Additionally, reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

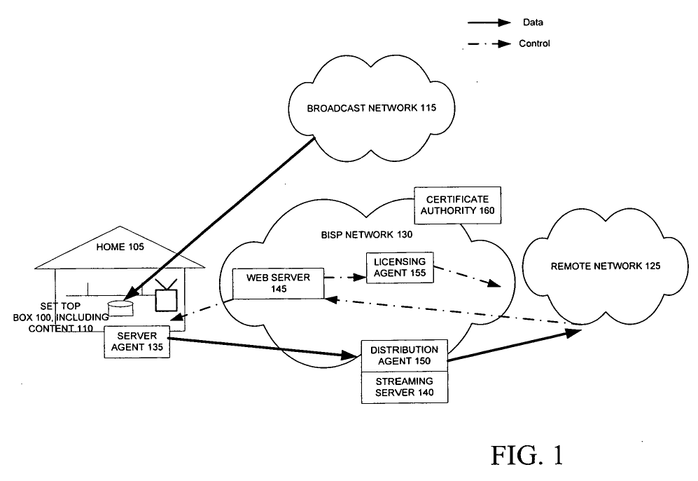

Embodiments of the present invention enable users to securely access their personal multimedia content from remote locations while retaining the ability to manipulate the content (hereafter referred to as “trick play”). The term “trick play” is well known to those of ordinary skill in the art and includes the ability to manipulate content, such as normal play, fast forward play and fast reverse play with time sequenced byte offsets. FIG. 1 illustrates an exemplary system according to an embodiment of the present invention. In one embodiment, the system includes a set top box (“Set Top Box 100”) at the user's home (“Home 105”) containing the user's stored personal multimedia content (“Content 110”), originally broadcast by a broadcast network (“Broadcast Network 115”). Examples of Broadcast Network 115 include satellite networks (e.g., Dish Network). As used herein, the term “set top box” shall include any content storage device that the broadcast network may transmit to and/or be aware of (e.g., a TiVOT™ and/or ReplayTV™ device). The system may additionally include a receiving device (“Receiving Device 120”) at a remote location (“Remote Network 125”) from which the user may access Content 10. Receiving Device 120 may comprise a stationary computing device (e.g., a personal computer at Remote Location 125) and/or a mobile computing device (e.g., a cellular telephone, a personal digital assistant (“PDA”) and/or other such device). Additionally, although Content 110 is illustrated as being stored at Home 105, embodiments of the present invention are not so limited. Instead, Content 110 may be stored at and/or accessible from any location the user may elect.

These components may be coupled together via a broadcast interactive service provider (“BISP Network 130”) network comprising an Internet Protocol (“IP) based broadcast network and IP-enabled end points. Examples of BISP network providers include companies such as Comcast, Verizon and/or a variety of emerging WiMax service providers. BISP networks are becoming increasingly common to address the problems of network latency, which is especially troublesome for streaming media content such as audio and/or video (e.g., jittery video streams). Thus, Broadcast Network 130 may be coupled to BISP Network 130 and may stream content to the BISP network, which maintains “streaming servers” in multiple locations on the network (illustrated collectively as “Streaming Server 140”). The concept of streaming servers is well known to those of ordinary skill in the art and further description thereof is omitted herein in order not to unnecessarily obscure embodiments of the present invention.

Streaming Server 140 may store and forward the content, i.e., not examine or manipulate the content, but rather simply store the media stream and then forward it as requested. Customers may therefore access their streaming content from a “local” BISP server source, i.e. one closer to their physical location than the broadcast network servers. Due to the proximity of the BISP servers to the customers, network latency becomes less of an issue and the user's viewing experience may be enhanced. According to one embodiment, Set Top Box 100 and Receiving Device 120 may act as IP-enabled end points on BISP Network 130. More particularly, Set Top Box 100 may serve as a personal content server (storing content from Broadcast Network 115) while Receiving Device 120 may act as a content-retrieving client.

The system of FIG. 1 may include various “agents” to enable embodiments of the present invention. Although for the purposes of discussion, the agents are presumed to be software agents, embodiments of the invention are not so limited. In various embodiments, the agents may comprise hardware, software, firmware and/or any combination thereof. Additionally, although the agents are illustrated as elements of BISP Network 130, these agents may reside elsewhere without departing from the spirit of embodiments of the present invention. As illustrated, Service Agent 135 may be associated with Set Top Box 100 and be capable of packaging Content 110 with associated metadata (hereafter “Packaged Content”) and exporting Packaged Content to BISP Network 130. Packaging the content may include transcoding (i.e., translating) the content to the target visual form factor, namely the form factor necessary for the user to access and view/hear the content on Receiving Device 120), content encryption (i.e., authentication and/or verification of the user and/or content), and/or generation of an index schedule table to enable trick play.

In one embodiment, Service Agent 135 may use various content identification and bandwidth selection information (e.g., information provided by the user) to choose appropriate transcoding context and configuration. More specifically, since devices today may utilize a variety of different content standards, Content 110 from Set Top Box 100 may have to be transcoded into a different format for use on a different device or form factor. Thus, for example, while PDAs today are typically power and performance constrained to handle only MPEG4 video, most set-top box content is typically MPEG2-based video. Transcoding therefore ensures that Content 110 is usable when the content is streamed from Streaming Server 140 to Receiving Device 120, regardless of what Receiving Device 120 comprises. The concept of transcoding is well known to those of ordinary skill in the art and further description thereof is omitted herein in order not to unnecessarily obscure embodiments of the present invention.

In addition to being transcoded, in one embodiment, Content 110 may also be encrypted using the “keys” provided and/or renewed by a licensing agent. Encryption and the functionality of licensing agents are described in further detail later in this specification. Service Agent 135 may also provide index table schedules for various trick play capabilities (e.g., normal play, fast forward play and fast reverse play with time sequenced byte offsets). Trick play is also described in further detail later in this specification.

BISP Network 130 may include a web server (“Web Server 145”), one or more associated distribution agent(s) (collectively “Distribution Agent 150”) and one or more associated licensing agent(s) (collectively “Licensing Agent 155”). In one embodiment, Distribution Agent 150 resides on Streaming Server 140 but other embodiments of the present invention are not so limited. In one embodiment, Web Server 145 may accept user requests and set up end-to-end flows (via its back end controllers) between Set Top Box 100 and Receiving Device 120. In various embodiments, Distribution Agent 150 on Streaming Server 140 may manage content streaming by pre-fetching and receiving Packaged Content from Service Agent 135 and streaming the content to Receiving Device 120. Each of the distribution agents on BISP Network 130 may manage multiple streaming flows. In one embodiment, to ensure real-time viewing of the streamed content by enhancing the flow for each of the streams, Distribution Agent 150 may assign each streaming flow a dedicated portion of a cache (e.g., a software controlled cache). In an embodiment, Licensing Agents 155 may serve licenses on demand to legitimate users. Licensing Agents 155 may additionally monitor Packaged Content to keep track of a variety of details, including identifying content fingerprints (i.e., track reception-quality), detecting copyright violations and/or measuring content consumption rate(s).

Although the above description assumes that each entity is a discrete component, embodiments of the present invention are not so limited. Instead, various components may be co-located and/or co-exist on one or more devices. Thus, for example, although the various agents are illustrated and described as discrete entities from Web Server 145, one or more agents may be co-located with Web Server 145. Similarly, although Distribution Agent 150 is illustrated as residing on Streaming Server 140, the agent may be a discrete entity from Streaming Server 140. Those of ordinary skill in the art will readily appreciate that various permutations of the illustrated configuration may be practiced without departing from the spirit of embodiments of the present invention.

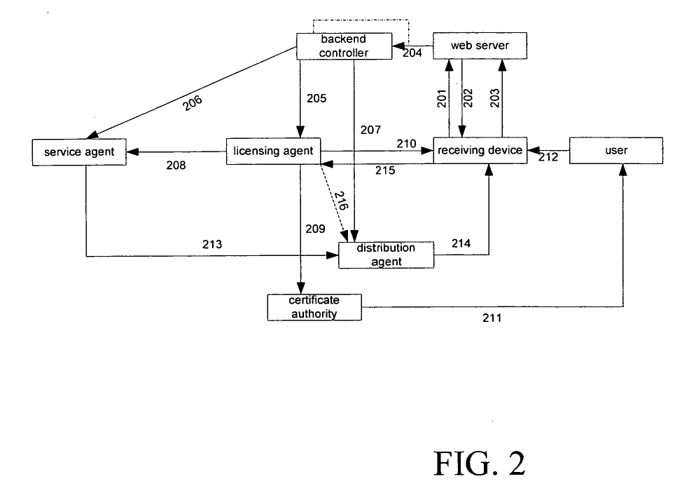

FIG. 2 illustrates conceptually an embodiment of the present invention. As illustrated, the user may remotely access his or her content from the user's Set Top Box 100 at Home 105 via Receiving Device 120 at Remote Location 125 in the following manner. The user may request access to the content by connecting to Web Server 145 on BISP Network 130 from Receiving Device 120 (illustrated by arrow 201). The user may be presented with a user interface to specify various parameters pertaining to the content that the user desires to access. The user interface may include a simple listing of all content on Set Top Box 100 and/or a more sophisticated presentation of the information (e.g., a “personalized” electronic programming guide (“EPG”) previously personalized with the user's personal preferences and/or a generic EPG name). In one embodiment, Service Agent 135 may export a personalized EPG for the user to Web Server 145. This personal EPG may comprise a customized version of the one supplied by Broadcast Network 115). The user may also make enter other information such as specifying bandwidth and/or entering a password and/or a personal identification number.

Upon receipt of the request from Receiving Device 120, Web Server 145 may authenticate the user and present the content to the user for selection (e.g., via the personalized EPG and/or the generic EPG, illustrated by arrow 202). The user may thereafter make a selection of content (illustrated by arrow 203) and the selection may be used to command backend controllers on BISP Network 130 (illustrated by arrow 204), to select and notify the various agents (e.g., Service Agent 135, Distribution Agent 150 and Licensing Agent 155), typically the agents located closest to the user's current position. The backend controllers on BISP Network 130 may thereafter map or transmit the request to the appropriate Licensing Agent 155 (illustrated by arrow 205), Service Agent 135 (illustrated by arrow 206) and Distribution Agent 150 (illustrated by arrow 207).

Licensing Agent 155 may ensure end-to-end content security by distributing and renewing licenses to the source (i.e., Set Top Box 100) and destination (i.e., Receiving Device 120). More specifically, Licensing Agent 155 may generate a pair of keys (e.g., by leveraging public key encryption methods to generate a public key and a private key) for Service Agent 135 and Receiving Device 120. The public key may be transmitted in the clear to Service Agent 135 (illustrated by arrow 208) while the private key may be transported Receiving Device 120 using a password as shared secret (illustrated by arrow 210). In one embodiment, Licensing Agent 155 may periodically update or renew the key pair, to ensure continued secure encryption during a session.

Licensing Agent 155 may additionally (simultaneously or otherwise) communicate with a certificate authority (“Certificate Authority 160”) to link the identities of users and their encryption key pairs using various certificates (e.g., X.509 certificates promulgated by International Standards Organization/International Electrotechnical Commission (“ISO/IEC”, 1998) and International Telecommunications Union (“ITU-T”, 1997)). Certificate authorities such as VeriSign, Thawte and Entrust are entities that are trusted to sign (i.e., issue) certificates for other entities, and since the concept of certificates and certificate authorities is well known to those of ordinary skill in the art, further description thereof is omitted herein. Licensing Authority 155 may thus provide a copy of the key pair to Certificate Authority 160 (illustrated by arrow 209), which may authenticate the content source (i.e., Set Top Box 100) and inform the user (via an authentication message to Receiving Device 120) whether the content is from a reliable source (illustrated by arrow 211). This typically occurs once per session, when the session is initialized.

Upon initialization of the session, Receiving Device 120 may utilize the private key from Licensing Agent 155 to decrypt the content and approve the content acquisition (illustrated by arrow 212). In one embodiment, Distribution Agent 150 may thereafter serve as the “master controller” for the session. More specifically, Distribution Agent 150 may create an instance of the cache controller on Streaming Server 160, with content source, destination and quality selections. Distribution Agent 150 (via the cache controller) may then pre-fetch the content from Service Agent 135 (illustrated by arrow 213) and stream the pre-fetched content to Receiving Device 120 (illustrated by arrow 214). As a result, in one embodiment, quality-of-service delivery may be the responsibility of Distribution Agent 150. To facilitate copyright protection, Licensing Agent 155 may also receive fingerprint blocks from Receiving Device 120 for later verification (illustrated by arrow 215). Fingerprinting typically includes a form of sophisticated hashing (i.e., a media friendly hashing as opposed to a simple data hashing) to monitor the quality of reception. The fingerprint processing configuration is content and user dependent (for subscriber management) and typically updated at license distribution time. Information pertaining to the streaming quality may be forwarded from Receiving Device 120 to Distribution Agent 150 for adaptation (illustrated by 216).

In one embodiment, Receiving Device 120 may include various navigation bars (standard or customized) to allow the user to perform trick play on the content received from Distribution Agent 150 (i.e., Packaged Content). Upon receipt by Receiving Device 120, Packaged Content may be decrypted using the context specific private key previously provided by Licensing Agent 155 to the Receiving Device. Packaged Content may thereafter be re-encrypted (e.g., using a variety of encryption algorithms including the Advanced Encryption Standard (“AES-CBC”)) with the key specifically supplied by a licensing agent on BISP Network 130, to authorize streaming.

Distribution Agent 150 may facilitate trick play by leveraging index tables supplied by Service Agent 135, without actually knowing the semantics of Packaged Content. Thus, in one embodiment, metadata in the form of look-up tables for normal play, fast forward play and/or rewind play may be supplied to Receiving Device 120. More specifically, prior to transmitting the Packaged Content to Receiving Device 120, Server Agent 134 may partition the Packaged Content into logical partitions (analogous to sectors in a disk). These logical partitions may be generated based on a variety of factors, including an offline analysis of the Packaged Content semantics. In one embodiment, the beginning of a scene may be used as the heuristic to identify key frames (i.e., starting points). The logical sectors may be encrypted (e.g., in the AES-CBC mode, with 128 bit cipher blocks) using local cryptography resources. As each sector is encrypted, the metadata may be generated, capturing the byte offsets for the entry points and associating these entry points with time code associated with the Packaged Content.

In one embodiment, the metadata comprises plain text, not cipher text, which allows Distribution Agent 150 to navigate the encrypted content. Thus, for example, Distribution Agent 150 may typically serve Packaged Content in a stream by following the normal play sequencing order as contained in the normal play look-up table. In one embodiment, when a fast forward request is received, Distribution Agent 150 recognizes the command and jumps to the fast forward look-up table. The correct row may be identified by matching the current playback time code with the fast forward time codes. Similarly a switch back to the normal playback is accomplished by matching the time codes.

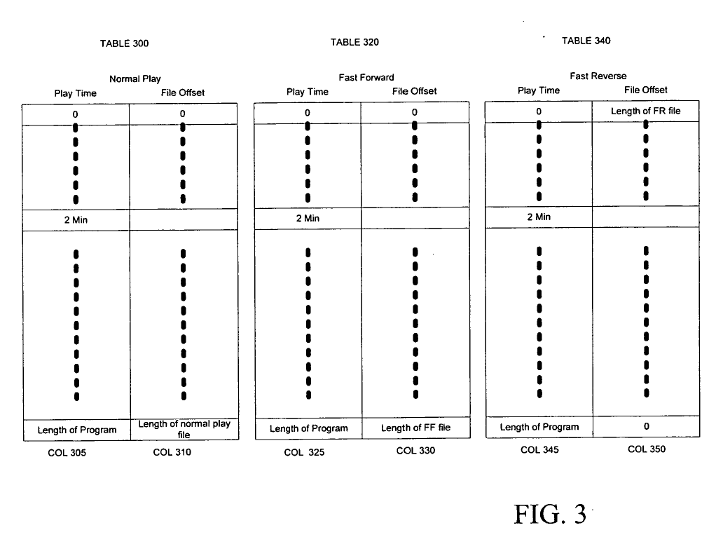

FIG. 3 illustrates the trick play capabilities described above in further detail. Distribution Agent 150 may receive three look-up tables, each corresponding to a particular type of trick play, e.g., Table 300 may correspond to normal play, Table 320 to fast forward play and Table 340 to fast reverse play. Other types of trick play may also be facilitated in various embodiments of the invention. In one embodiment, each table comprises two columns, one representing a time code (Cols. 305, 325 and 345) and the other representing the key frame, i.e., the frame where a scene changes (Cols. 310, 330 and 350). In one embodiment, Distribution Agent 150 may utilize the contents of the tables to enable trick play, despite the fact that Distribution Agent 150 has no idea about the actual details of Packaged Content. Thus, for example, in one embodiment, Distribution Agent 155 may identify the requested table, based on the content play type (e.g., fast forward play) on Receiving Device 120, and Distribution Agent 155 may thereafter search the appropriate table (e.g., Table 320) using a time code and/or sequence number as an index. Once the byte offset for the key frame (e.g., a group of pictures (“GOP”) number) of interest is located, this is translated to a disk sector number and span length for retrieval. The key frame context register is programmed with the sector number of the next adjacent key frame.

As a result, in one embodiment, Distribution Agent 155 merely serves as the cache controller for the mobile player, without any idea of the semantics of Packaged Content. For example, when a user begins playing a content stream, Distribution Agent 150 may examine Table 300 (normal play) to determine the time offset pointing to which frame is playing. Thereafter, if the user fast forwards the stream, Distribution Agent 150 switches to Table 320 (fast forward play), finds the appropriate offset of the currently playing frame, and proceeds to stream frames according to the fast forward table, i.e., effectively dropping certain frames to effect the fast forward. When the user ends the fast forward and goes back to normal play, Distribution Agent 150 once again switches to Table 300 and looks up the current offset in the table to determine where to continue streaming.

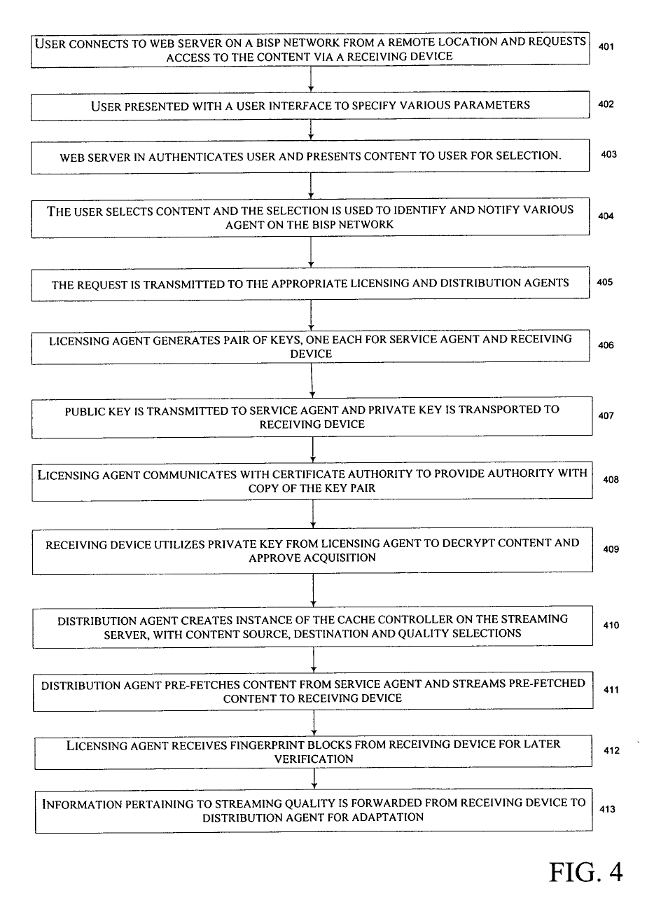

FIG. 4 is a flow chart illustrating the operations within a system according to an embodiment of the present invention. Although the following operations may be described as a sequential process, many of the operations may in fact be performed in parallel and/or concurrently. In addition, the order of the operations may be re-arranged without departing from the spirit of embodiments of the invention. In 401, the user may connect to a web server on a BISP network from a remote location, and request access to the content via a receiving device. The user may then be presented with a user interface in 402, to enable the user to specify various parameters pertaining to the content that the user desires to access. Upon receipt of the request from the receiving device, the web server in 403 may authenticate the user and present the content to the user for selection. The user may thereafter make a selection of content and the selection may be used to command backend controllers on the BISP network in 405, to select and notify the various agents, typically the agents located closest to the user's current position. The backend controllers on the BISP network may thereafter map or transmit the request to the appropriate licensing agent and distribution agent in 405.

The licensing agent may generate a pair of keys, one each for the service agent and the receiving device in 406. In 407, the public key may be transmitted in the clear to the service agent while the private key may be transported to the receiving device using a password as shared secret. In one embodiment, the licensing agent may periodically update or renew the key pair, to ensure continued secure encryption during a session. The licensing agent may additionally (simultaneously or otherwise) communicate with a certificate authority in 408 to provide the authority with a copy of the key pair capable of authenticating the content source and informing the user whether the content is from a reliable source.

Upon initialization of the session, in 409, the receiving device may utilize the private key from the licensing agent to decrypt the content and approve the content acquisition. In one embodiment, the distribution agent may create an instance of the cache controller on the streaming server in 410, with content source, destination and quality selections. In 411, the distribution agent (via the cache controller) may then pre-fetch the content from the service agent and stream the pre-fetched content to the receiving device. To facilitate copyright protection, the licensing agent may also receive fingerprint blocks from the receiving device in 412, for later verification. Information pertaining to the streaming quality may be forwarded in 413 from the receiving device to the distribution agent for adaptation.

The set-top box, servers and/or remote receiving devices according to embodiments of the present invention may be implemented on a variety of computing devices. According to an embodiment of the present invention, these computing devices may include various components capable of executing instructions to accomplish an embodiment of the present invention. For example, the computing devices may include and/or be coupled to at least one machine-accessible medium. As used in this specification, a “machine” includes, but is not limited to, any computing device with one or more processors. As used in this specification, a machine-accessible medium includes any mechanism that stores and/or transmits information in any form accessible by a computing device, the machine-accessible medium including but not limited to, recordable/non-recordable media (such as read-only memory (ROM), random-access memory (RAM), magnetic disk storage media, optical storage media and flash memory devices), as well as electrical, optical, acoustical or other form of propagated signals (such as carrier waves, infrared signals and digital signals).

According to an embodiment, a computing device may include various other well-known components such as one or more processors. The processor(s) and machine-accessible media may be communicatively coupled using a bridge/memory controller, and the processor may be capable of executing instructions stored in the machine-accessible media. The bridge/memory controller may be coupled to a graphics controller, and the graphics controller may control the output of display data on a display device. The bridge/memory controller may be coupled to one or more buses. One or more of these elements may be integrated together with the processor on a single package or using multiple packages or dies. A host bus controller such as a Universal Serial Bus (“USB”) host controller may be coupled to the bus(es) and a plurality of devices may be coupled to the USB. For example, user input devices such as a keyboard and mouse may be included in the computing device for providing input data. In alternate embodiments, the host bus controller may be compatible with various other interconnect standards including PCI, PCI Express, FireWire and other such current and future standards.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

1. A system for enabling remote access, comprising:
a licensing agent capable of responding to a request for access to multimedia content, the licensing agent capable of generating and distributing a private key and a public key for the multimedia content; and
a distribution agent coupled to the licensing agent, the distribution agent capable of pre-fetching the multimedia content and streaming the content to a receiving device.

2. The system according to claim 1 further comprising a service agent coupled to the licensing agent, the service agent capable of receiving the public key from the licensing agent and utilizing the public key to encrypt the multimedia content, the distribution agent further coupled to the service agent and capable of pre-fetching the encrypted multimedia content and streaming the content to the receiving device.

3. The system according to claim 2 wherein the licensing agent is further capable of transmitting the private key to the receiving device, the receiving device capable of presenting the multimedia content to the user.

4. The system according to claim 3 wherein the receiving device may utilize the private key to decrypt the multimedia content upon receipt of the multimedia content from the distribution agent.

5. The system according to claim 4 further comprising a certificate authority capable of receiving a copy of the public key and the private key from the licensing agent, the certificate authority further capable of authenticating a source of the multimedia content.

6. The system according to claim 2 wherein the service agent is further capable of generating trick play metadata for the multimedia content.

7. The system according to claim 6 wherein the distribution agent is further capable of utilizing the trick play metadata to respond to trick play requests from the user.

8. A system for enabling remote access, comprising:
a web server capable of storing information pertaining to multimedia content, the web server further capable of receiving a request from a user for access to the multimedia content via a receiving device;
a licensing agent coupled to the web server, the licensing agent capable of responding to the request for access to the multimedia content from the web server, the licensing agent further capable of generating and distributing a private key and a public key for the multimedia content; and
a distribution agent coupled to the licensing agent and the service agent, the distribution agent capable of pre-fetching the remote content and streaming the content to the receiving device.

9. The system according to claim 8 further comprising a service agent coupled to the web server and the licensing agent, the service agent capable of receiving the public key from the licensing agent and utilizing the public key to encrypt the multimedia content.

10. The system according to claim 8 further comprising a certificate authority capable of authenticating the multimedia content from the web server.

11. The system according to claim 9 wherein the service agent is further capable of generating trick play metadata for the multimedia content.

12. The system according to claim 11 wherein the distribution agent is further capable of utilizing the trick play metadata to respond to trick play requests from the user.

13. A system comprising:
a web server capable of storing information pertaining to multimedia content, the web server further capable of receiving a request from a user for access to the multimedia content via a receiving device; and
a licensing agent coupled to the web server, the licensing agent capable of responding to the request for access to the multimedia content from the web server, the licensing agent further capable of generating and distributing a private key and a public key for the multimedia content.

14. The system according to claim 13 wherein the licensing agent is further capable of interacting with a service agent, the service agent capable of receiving the public key from the licensing agent and utilizing the public key to encrypt the multimedia content.

15. A system comprising:
a web server capable of storing information pertaining to multimedia content, the web server further capable of receiving a request from a user for access to the multimedia content via a receiving device; and
a service agent capable of receiving a public key from the licensing agent and utilizing the public key to encrypt the multimedia content.

16. The system according to claim 15 wherein the service agent is further capable of generating trick play metadata for the multimedia content.

17. The system according to claim 16 wherein the service agent is further capable of interacting with a distribution agent, the distribution agent capable of pre-fetching the multimedia content from the service agent and streaming the multimedia content to the receiving device.

18. A system comprising:
a web server capable of storing information pertaining to multimedia content, the web server further capable of receiving a request from a user for access to the multimedia content via a receiving device, the web server additionally capable of providing the content to a service agent; and
a distribution agent capable of pre-fetching the multimedia content from the service agent and streaming the multimedia content to the receiving device.

19. The system according to claim 18 wherein the distribution agent is further capable of utilizing trick play metadata streamed with the multimedia content to respond to trick play requests from the user.

20. A method for remotely accessing multimedia content, comprising:
generating and distributing a private key and a public key for the multimedia content;
pre-fetching the multimedia content and trick play metadata for the multimedia content; and
streaming the multimedia content and the trick play metadata to a remote receiving device.

21. The method according to claim 20 further comprising utilizing the public key to encrypt the multimedia content prior to streaming the multimedia content and the trick play metadata to the remote receiving device.

22. The method according to claim 21 further comprising the remote receiving device receiving and utilizing the private key to decrypt the multimedia content.

23. The method according to claim 20 further comprising utilizing the trick play metadata to respond to trick play requests from the user.

24. The method according to claim 23 wherein generating the trick play metadata further comprises generating a normal play table, a fast forward play table and a rewind play table.

25. The method according to claim 24 wherein utilizing the trick play metadata further comprises utilizing entries in at least one of the normal play table, the fast forward play table and the rewind play table to respond to the trick play requests from the user.

26. The method according to claim 25 wherein the entries comprise a time code and a byte offset for each key frame in the multimedia content.

27. An article comprising a machine-accessible medium having stored thereon instructions that, when executed by a machine, cause the machine to remotely access multimedia content by:
generating and distributing a private key and a public key for the multimedia content;
pre-fetching the multimedia content and trick play metadata for the multimedia content; and
streaming the multimedia content and the trick play metadata to a remote receiving device.

28. The article according to claim 27 wherein the instructions, when executed by the machine, further cause the machine to utilize the public key to encrypt the multimedia content prior to streaming the multimedia content and the trick play metadata to the remote receiving device.

29. The article according to claim 27 wherein the instructions, when executed by the machine, further cause the machine to utilize the trick play metadata to respond to trick play requests from the user.

30. The article according to claim 29 wherein the instructions, when executed by the machine, further cause the machine to generate a normal play table, a fast forward play table and a rewind play table.

31. The article according to claim 30 wherein the instructions, when executed by the machine, further cause the machine to utilize entries in at least one of the normal play table, the fast forward play table and the rewind play table to respond to the trick play requests from the user, the entries comprising a time code and a byte offset for each key frame in the multimedia content.
